(19) United States
(12) Patent Application Publication
(10) Pub. No.: US 2022/0383249 A1
(43) Pub. Date: Dec. 1, 2022

(54) INGREDIENT MANAGEMENT SUPPORT APPARATUS, AND INGREDIENT MANAGEMENT SUPPORT METHOD

(71) Applicant: Cookpad Inc., Kanagawa (JP)

(72) Inventor: Genta KANEYAMA, Kanagawa (JP)

(73) Assignee: Cookpad Inc., Kanagawa (JP)

(21) Appl. No.: 17/885,544

(22) Filed: Aug. 11, 2022

Related U.S. Application Data
(63) Continuation of application No. PCT/JP2021/015941, filed on Apr. 20, 2021.

(30) Foreign Application Priority Data
Apr. 28, 2020 (JP) 2020-078842

(51) Int. Cl. G06Q 10/08

(52) U.S. Cl. CPC G06Q 10/087

(57) ABSTRACT

An ingredient management support apparatus 1 includes a storage unit 101 for storing recipe information used by a user, an information acquiring unit 102 for confirming with the user, with regard to a dish based on the recipe information, information on a surplus ingredient remaining after making the dish, based on ingredient information indicated by the recipe information, and acquiring the information on the surplus ingredient from a given device 200 and an identifying unit 103 for identifying an existing ingredient possessed by the user based on the information on the surplus ingredient.

### CROSS-REFERENCE TO RELATED APPLICATIONS

This application is a Continuation application of No. PCT/JP2021/015941, filed on Apr. 20, 2021, and the PCT application is based upon and claims the benefit of priority from Japanese Patent Application No. 2020-078842, filed on Apr. 28, 2020, the entire contents of which are incorporated herein by reference.

### TECHNICAL FIELD

The present disclosure relates to an ingredient management support apparatus, an ingredient management support system, an ingredient management support method, and an ingredient management support program.

### BACKGROUND ART

Each household purchases ingredients for daily meals and consumes them by cooking, etc. Accordingly, purchased ingredients are stored in a refrigerator or the like as appropriate until the time for use comes. Since such ingredients are repeatedly purchased and consumed on a daily basis, it is difficult for the user of the ingredients to grasp the ingredients possessed by themselves.

If the user themselves performs the above-described management, the user has to do troublesome work such as registering and updating ingredient information by themselves. Therefore, it is not rare that the possessed ingredients are not accurately grasped, their existence is forgotten, and they are eventually disposed.

As a conventional technique for solving such a problem, for example, Japanese Patent Application Publication No. 2009-259015 discloses a concept of attaching a wireless tag to a food item to be stored in a refrigerator, reading food item information of a food item in the refrigerator by wireless communication, and acquiring food item information in the refrigerator.

Specifically, disclosed is a menu proposal apparatus including: a storage for storing one or more food items to which wireless tags storing food item information are attached respectively; a database in which food items required as ingredients are registered for each menu; a reading unit for reading the food item information of each of the stored food items by wireless communication with the wireless tag in the storage; a determination unit for determining, with reference to the database, a menu that can be made using food items of the read food item information; and a notification unit for notifying the menu determined to be able to be made.

However, in order to adopt the configuration as in the conventional technology, it is necessary to establish a situation in which tags are given to respective ingredients from the distribution stage, and this cannot be a practical solution in view of the current situation of tag introduction in the distribution industry. Also, it is necessary to add ancillary functions such as a tag reader to the refrigerator, which is not a small burden on the user side.

Namely, performing ingredient management by the user themselves has a problem in terms of labor and accuracy, and the conventional technology has a problem that the feasibility is low even if the technology is desired to be adopted, and after all, it has been impossible to perform ingredient management in a preferred manner.

### BRIEF DESCRIPTION OF THE DRAWINGS

FIG. 1 is a diagram showing an example network configuration including an ingredient management support apparatus in a present embodiment.

FIG. 2 is a diagram showing an example configuration of a recipe DB in the present embodiment.

FIG. 3 is a diagram showing an example configuration of an ingredient management DB in the present embodiment.

FIG. 4 is a diagram showing an example configuration of operation information in the present embodiment.

FIG. 5 is a diagram showing an example flow of an ingredient management support method in the present embodiment.

FIG. 6 shows an example screen in the present embodiment.

FIG. 7 shows an example screen in the present embodiment.

FIG. 8 is a diagram showing a schematic configuration of a computer in the present embodiment.

### DETAILED DESCRIPTION

The present embodiment will be described below. It should be noted that the present embodiment described below does not unduly limit the contents of the present disclosure described in the claims. Not all of the configurations described in the present embodiment are essential constituent elements of the present disclosure.

In order to solve the above-mentioned problems, an ingredient management support apparatus of the present disclosure includes a storage unit for storing recipe information used by a user, an information acquiring unit for confirming with the user, with regard to a dish based on the recipe information, information on a surplus ingredient remaining after making the dish, based on ingredient information indicated by the recipe information, and acquiring the information on the surplus ingredient from a given device, and an identifying unit for identifying an existing ingredient possessed by the user based on the information on the surplus ingredient.

Also, an ingredient management support system of the present disclosure includes an information processing apparatus including a storage unit for storing recipe information used by a user, an information acquiring unit for confirming with the user, with regard to a dish based on the recipe information, information on a surplus ingredient remaining after making the dish, based on ingredient information indicated by the recipe information, and acquiring the information on the surplus ingredient from a given device, and an identifying unit for identifying an existing ingredient possessed by the user based on the information on the surplus ingredient.

In an ingredient management support method of the present disclosure, an information processing apparatus storing recipe information used by a user performs a process of confirming with the user, with regard to a dish based on the recipe information, information on a surplus ingredient remaining after making the dish, based on ingredient information indicated by the recipe information, and acquiring the information on the surplus ingredient from a given device, and a process of identifying an existing ingredient possessed by the user based on the information on the surplus ingredient.

Also, an ingredient management support program of the present disclosure causes an information processing apparatus storing recipe information used by a user to perform a process of confirming with the user, with regard to a dish based on the recipe information, information on a surplus ingredient remaining after making the dish, based on ingredient information indicated by the recipe information, and acquiring the information on the surplus ingredient from a given apparatus, and a process of identifying an existing ingredient possessed by the user based on the information on the surplus ingredient.

<Configuration>

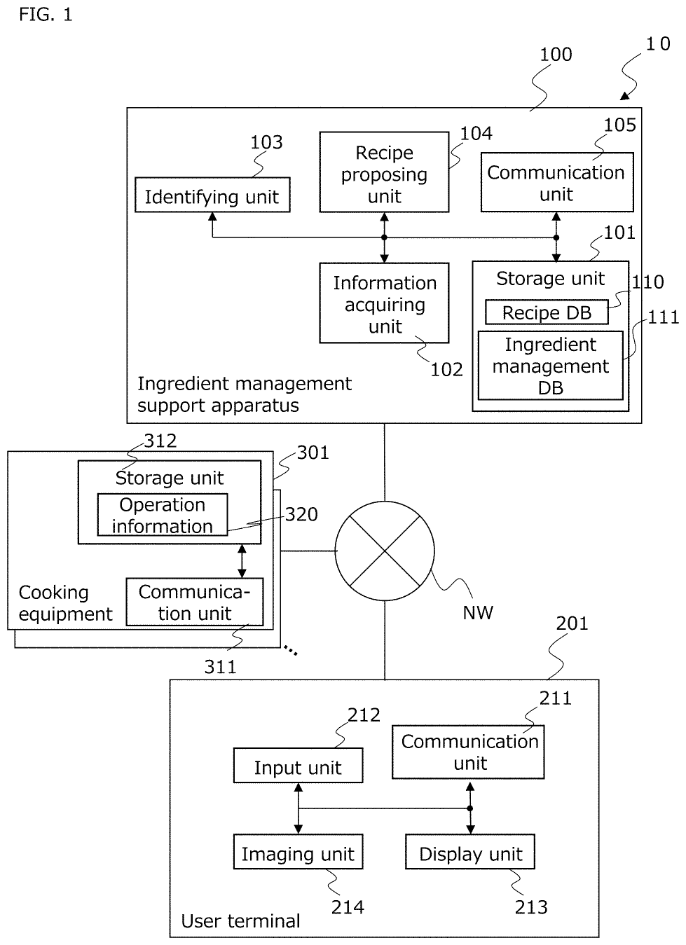

First, a configuration and outline of an ingredient management support system 10 including an ingredient management support apparatus 100 in the present embodiment will be described with reference to FIG. 1. FIG. 1 is a block diagram of devices constituting the ingredient management support system 10 of the present embodiment.

In the ingredient management support system 10 according to the present embodiment, as shown in FIG. 1, an ingredient management support apparatus 100, a user terminal 201, and cooking equipment 301 are configured to be connectable to a network NW such as the Internet or a LAN.

The ingredient management support apparatus 100 is composed of an information processing apparatus such as a computer or a mainframe. The connection between the ingredient management support apparatus 100 and the network NW may be wired or wireless. The ingredient management support apparatus 100 includes a storage unit 101, an information acquiring unit 102, an identifying unit 103, a recipe proposing unit 104, and a communication unit 105.

Of these, the storage unit 101 stores a recipe DB 110 that stores recipe information and an ingredient management DB 111. Of these, the recipe DB 110 is a database of recipe information, which is information for making a dish, which describes information on ingredients used for the dish and cooking details.

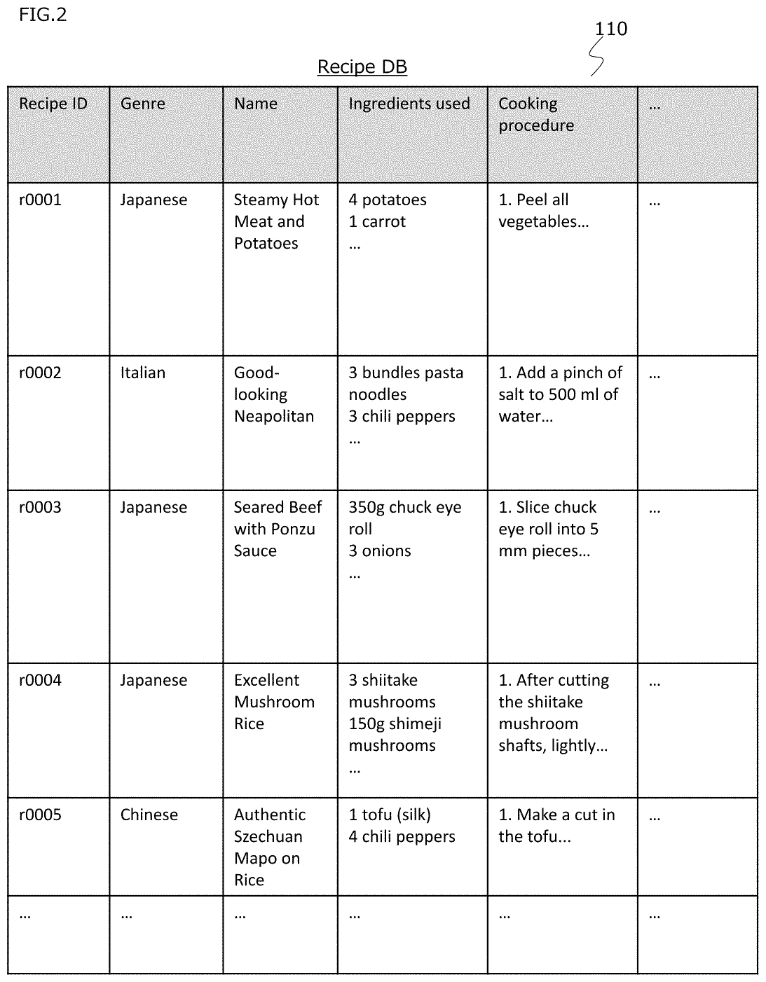

FIG. 2 shows an example configuration of the recipe DB 110 of the present embodiment. As shown in FIG. 2, the recipe DB 110 stores a record in which information such as the genre, name, ingredients used, and cooking procedure of a recipe is associated with a recipe ID, which uniquely identifies recipe information, as a key.

Each piece of recipe information (each record) included in the recipe DB 110 may be a content composed of an image and a text, or may be a moving image. The recipe information managed by the ingredient management support apparatus 100 in the recipe DB 110 may be posted by a user (contributor or viewer) of a given recipe posting site, or may be posted by a given service provider.

In the following description, a situation in which the ingredient management support apparatus 100 provides an ingredient management support service to a user of the aforementioned recipe posting site will be assumed as an example. This user is a person who prepares a dish using their own cooking equipment with reference to recipe information posted on the recipe posting site.

When preparing a dish, the user purchases additional ingredients (additional ingredients) as necessary in addition to ingredients already possessed (existing ingredients), and uses these ingredients in the dish.

Although these existing ingredients and additional ingredients are consumed as the dish is prepared, some of the ingredients remain unused and become surplus ingredients (of course, there are cases in which all of the ingredients are used up).

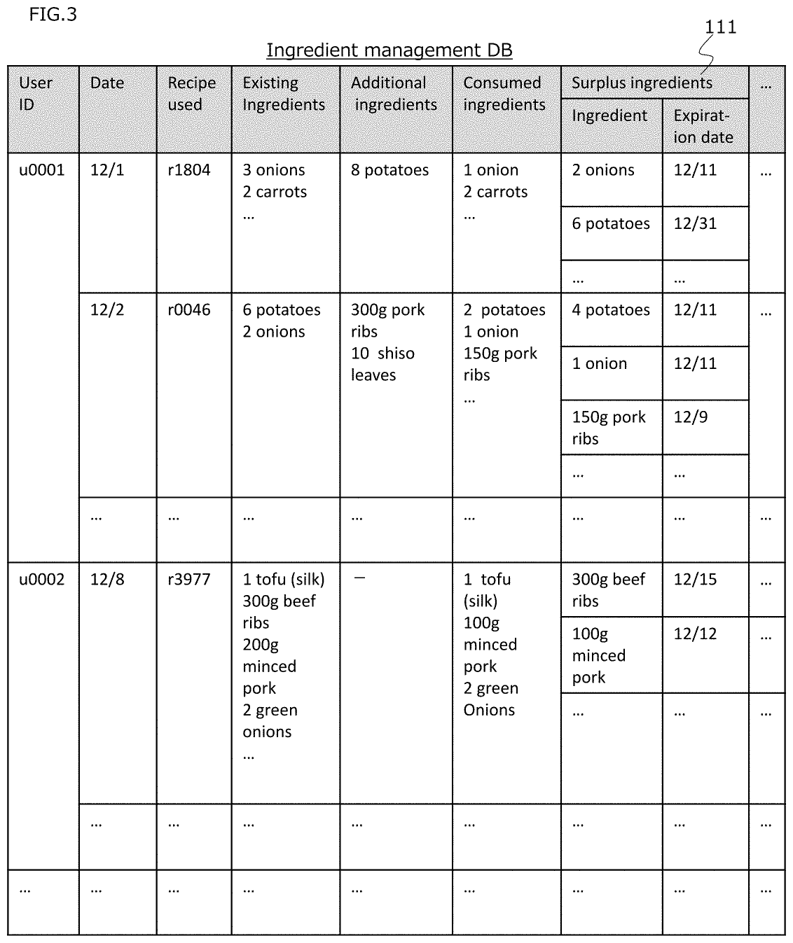

FIG. 3 shows an example configuration of the ingredient management DB 111 of the present embodiment. The storage unit 101 is a database storing various types of information on a recipe used and additional ingredients of each user, which are acquired by the information acquiring unit 102 from the user terminal 201 (or the cooking equipment 301).

Each piece of information stored in the ingredient management DB 111 is stored such that values such as the date when the recipe was used, recipe used, existing ingredients, additional ingredients, consumed ingredients, and surplus ingredients are associated with a user ID, which uniquely identifies a user, as a key. Of these, the information acquired from the user terminal 201 is the values of the date when the recipe was used, recipe used, additional ingredients, and surplus ingredients.

In contrast, the information on the existing ingredients is extracted and set by the identifying unit 103 of the ingredient management support apparatus 100 taking the difference between the information in the column of ingredients used of the relevant recipe in the recipe DB 110 and the information on additional ingredients acquired from the user terminal 201. The information on surplus ingredients includes not only information on the name and quantity of the ingredient, but also information on the expiration date.

Further, the information on consumed ingredients is extracted and set by the identifying unit 103 of the ingredient management support apparatus 100 taking the difference between information obtained by merging the information in the column of the ingredients used of the relevant recipe in the recipe DB 110 with the aforementioned information on additional ingredients acquired from the user terminal 201 and the information on surplus ingredients.

It is assumed that the information acquiring unit 102 transmits recipe information held in the recipe DB 110 to the user terminal 201 for output, asks questions about the recipe used by the user, the date of use, ingredients additionally purchased for the recipe, and ingredients remaining as a result of making a dish based on the recipe, i.e., surplus ingredients, and acquires answers to the questions, thereby acquiring each piece of information necessary for generating a record in the ingredient management DB 111.

In addition, the information acquiring unit 102 may acquire captured image data on the aforementioned surplus ingredients of the user from (an imaging unit 214 of) the user terminal 201, and acquire, based on the captured image data, information on the surplus ingredients that the user has come to possess. In this case, the information acquiring unit 102 can be assumed to be operated to input captured image data including an image of the aforementioned surplus ingredients to, for example, an image analysis engine obtained in advance by machine learning with ingredient images regarding ingredients and their quantities, and estimate the surplus ingredients and their quantities.

Alternatively, the information acquiring unit 102 may process the aforementioned captured image data using an OCR algorithm held in advance or available so as to recognize printed characters or the like on the surface of the food packaging and identify the name and quantity of the ingredient.

The information acquiring unit 102 may also acquire operation information 320 of the cooking equipment 301, i.e., cooking means of the user, which can communicate via the network NW, from the cooking equipment 301. The operation information 320 includes recipe information set in the cooking equipment 301 and information on operation details executed based on the recipe information.

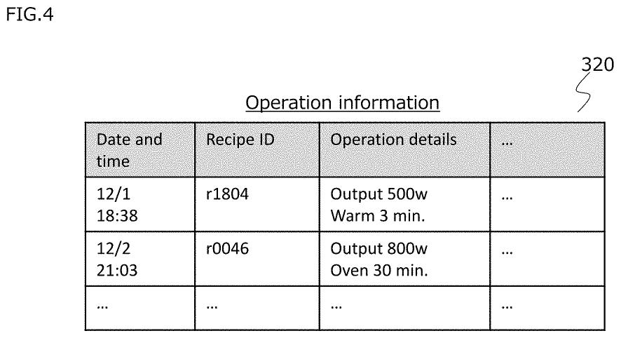

FIG. 4 shows a specific example configuration of the operation information 320. As illustrated in FIG. 4, the operation information 320 is composed of a record including values such as the date and time when the cooking equipment 301 was operated, the recipe ID of the set recipe information, and the operation details.

In this case, the information acquiring unit 102 passes the aforementioned operation information 320 acquired from the cooking equipment 301 to the identifying unit 103. The identifying unit 103 compares the operation information 320 with information (included in one record of the ingredient management DB 111) on the date when the recipe was used, recipe used, and surplus ingredients, which is acquired by the information acquiring unit 102 from the user terminal 201, thereby enabling confirming, also from the information derived from the cooking equipment 301, that the user has indeed prepared a dish using the recipe, that is, used the ingredients. Therefore, the accuracy of identifying the existing ingredients can be assured based on the recipe information that has been confirmed to be used in this way.

As described above, the identifying unit 103 identifies existing ingredients possessed by the user based on the information on the recipe used, additional ingredients, and surplus ingredients acquired from the user terminal 201. In this case, the identifying unit 103 identifies the ingredients excluding the additional ingredients among the ingredients used indicated by the recipe information used by the user as existing ingredients possessed by the user before making a dish using the recipe information.

It should be noted that the identifying unit 103 identifies the ingredients excluding the surplus ingredients among the aforementioned existing ingredients and additional ingredients as consumed ingredients consumed by making the dish using the recipe information. Then, the identifying unit 103 manages the aforementioned information on existing ingredients, additional ingredients, consumed ingredients, and surplus ingredients in time series.

The recipe proposing unit 104 identifies, based on information on surplus ingredients held in the aforementioned ingredient management DB 111, a recipe that can be cooked with the surplus ingredients from the recipe information in the recipe DB 110, and outputs the recipe information to the user terminal 201.

When identifying the recipe information, it is preferable that the recipe proposing unit 104 preferentially selects an ingredient that is currently possessed as a surplus ingredient even after making the dish and has a close expiration date among the additional ingredients in the ingredient management DB 111, and identifies a recipe using the selected ingredient from the recipe DB 110.

It is more preferable that the recipe proposing unit 104 identifies recipe information from the recipe DB 110 in descending order of the number of ingredients which the user needs to newly purchase, based on the information on surplus ingredients held in the ingredient management DB 111 for the user (i.e., ingredients currently possessed) and the recipe information held in the recipe DB 110.

Next, the communication unit 105 is a communication interface that communicates with the user terminal 201 and the cooking equipment 301 via the network NW. The communication unit 105 receives information on additional ingredients, surplus ingredients, and the like transmitted from the user terminal 201 and operation information 320 transmitted from the cooking equipment 301. The communication unit 105 also transmits information on a recipe to be proposed to the user terminal 201.

On the other hand, the user terminal 201 constituting the ingredient management support system 10 together with the ingredient management support apparatus 100 displays information transmitted from the ingredient management support apparatus 100. The user terminals 201 can also transmit information to the ingredient management support apparatus 100.

The user terminal 201 is an information processing apparatus, such as a smart phone, a mobile phone, a PHS, a computer, a PDA, a wristwatch, a smart watch, a head-mounted display, or an image generation device, which can be connected to the ingredient management support apparatus 100 via a network NW such as the Internet (WAN) or a LAN. The connection between the user terminal 201 and the ingredient management support apparatus 100 may be wired or wireless.

In addition, the user terminal 201 may access the ingredient management support apparatus 100 through installed dedicated application software. The user terminal 201 may access the ingredient management support apparatus 100 by means of an operating environment (an application programming interface (API), a platform, or the like) provided by the ingredient management support apparatus 100 or a separate server (not shown).

The communication unit 211 is a communication interface that communicates with the ingredient management support apparatus 100 via the network NW. The communication unit 211 receives recipe information transmitted from the ingredient management support apparatus 100. The communication unit 211 also transmits information on additional ingredients and surplus ingredients, or recipe selection information to the ingredient management support apparatus 100.

The input unit 212 is an input device for the user to perform an operation on the user terminal 201. The input unit 212 may be an input device using a switch, such as a physical keyboard, or may be integrated with the display unit 213 to be configured as a touch panel.

The display unit 213 is an image device for displaying information on the user terminal 201, and is composed of a liquid crystal display (LCD), an organic EL element, or the like.

The cooking equipment 301 is a device such as a microwave oven, an oven range, a rice cooker, or a refrigerator. It is assumed that the cooking equipment 301 in this case includes a communication unit 311 and a storage unit 312, and can communicate with the ingredient management support apparatus 100 via the network NW such as the Internet (WAN) or a LAN.

Therefore, the operation information 320 (see FIG. 4) of the cooking equipment 301 held in the storage unit 312 can be transmitted to the ingredient management support apparatus 100 via the communication unit 311. The connection between the cooking equipment 301 and the ingredient management support apparatus 100 may be wired or wireless.

The communication unit 311 is a communication interface that communicates with the ingredient management support apparatus 100 via the network NW. The communication unit 311 receives an acquisition request for operation information 320, which is transmitted from the ingredient management support apparatus 100. The communication unit 311 also transmits operation information 320 to the ingredient management support apparatus 100.

<Processing Flow>

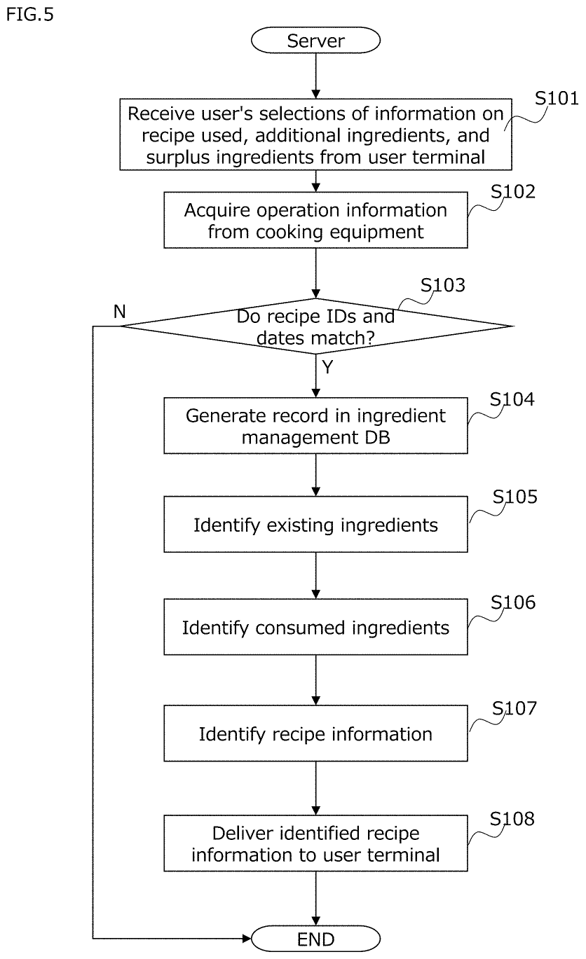

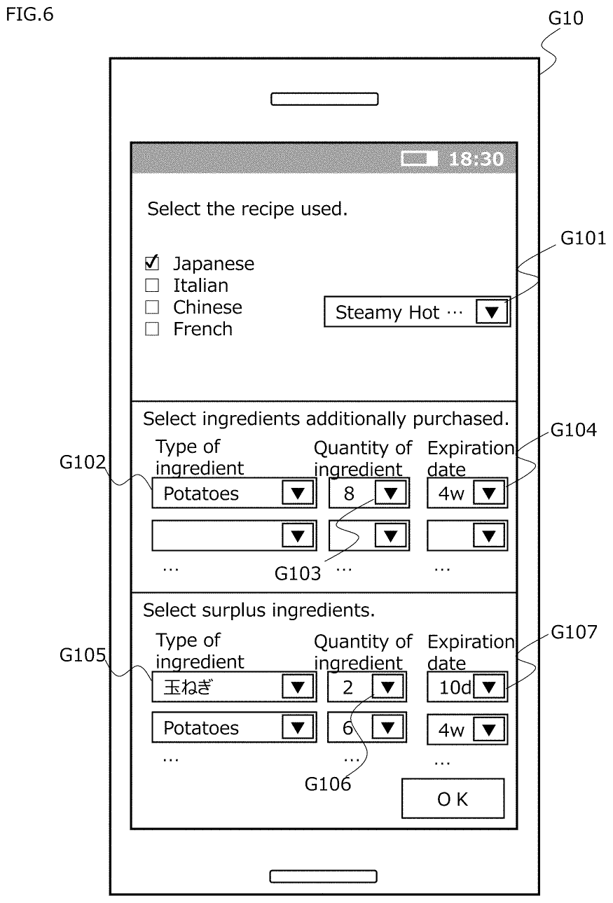

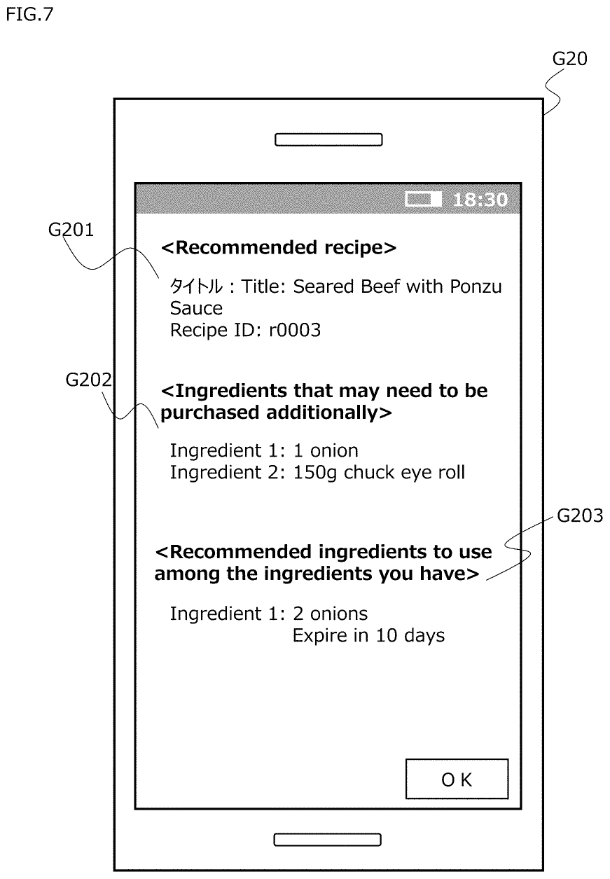

Next, an ingredient management support method in the present embodiment will be described with reference to the flowchart shown in FIG. 5 as well as FIGS. 6, 7, etc. showing display screens of the user terminal 201. The flowchart of FIG. 5 shows operations performed by the ingredient management support apparatus 100 in cooperation with the user terminal 201 and the cooking equipment 301 as needed.

In step S101, the information acquiring unit 102 of the ingredient management support apparatus 100 delivers the screen G10 shown in FIG. 6, for example, to the user terminal 201, and receives user's selections of information on the recipe used, additional ingredients, and surplus ingredients via the screen G10.

In this case, the user views the screen G10 of the user terminal 201, and inputs, via the input unit 212, a selection of the ID of the recipe used for making a dish, a selection of the ingredients additionally purchased for making the dish, i.e., additional ingredients, and a selection of the ingredients remaining after making the dish, i.e., surplus ingredients.

In the screen G10 in FIG. 6, a pull-down menu G101 for the user to select a recipe used, pull-down menus G102 to G104 for the user to select an additional ingredient, quantity, and expiration date, and pull-down menus G105 to G107 for the user to select a surplus ingredient, quantity, and expiration date are listed.

As the pull-down menu G102 and pull-down menu G105, for example, a menu in which values of ingredients indicated in the column of ingredients used included in each piece of recipe information of the recipe DB 110 are listed can be assumed to be set. As the pull-down menu G103 and pull-down menu G106, for example, a menu in which values of the quantities of the ingredients indicated in the column of ingredients used included in each piece of recipe information of the recipe DB 110 are listed can be assumed to be set.

In the lists shown by such pull-down menus, the user designates ingredients additionally purchased by the user and their quantities and expiration dates, and surplus ingredients and their quantities and expiration dates. The values designated by the user are returned from the user terminal 201 to the ingredient management support apparatus 100. The ingredient management support apparatus 100 thereby acquires the information on additional ingredients and surplus ingredients from the user terminal 201.

In step S102, the information acquiring unit 102 of the ingredient management support apparatus 100 acquires the operation information 320 held by the cooking equipment 301 by requesting the cooking equipment 301 or in response to sensing of the arrival of the autonomous transmission timing at the cooking equipment 301.

In step S103, the ingredient management support apparatus 100 receives the information on the recipe used, additional ingredients, and surplus ingredients transmitted from the user terminal 201 in step S101 and the operation information 320 transmitted from the cooking equipment 301 in step S102, and determines whether the recipe IDs and dates of the information obtained in both steps match, that is, whether the information obtained in both steps are observations of one event, in which certain recipe information is used for making a dish on a given date, at different devices.

When the recipe IDs and dates do not match (S103: N) as a result of the above-described determination, the information acquiring unit 102 of the ingredient management support apparatus 100 terminates the processing. On the other hand, when the recipe IDs and dates match (S103: Y) as a result of the above-described determination, the information acquiring unit 102 of the ingredient management support apparatus 100 identifies, in step S104, the information on additional ingredients and surplus ingredients acquired from the user terminal 201 as certain, and generates a record for the user in the ingredient management DB 111.

It should be noted that the record generated by the information acquiring unit 102 includes only information on the user ID, date, recipe used, additional ingredients, and surplus ingredients. In other words, the other information on the existing ingredients and consumed ingredients has not been set.

It should be noted that the acquisition of the operation information 320 (S102) and the determination using the information (S103) described above are optional and are not essential processes in the ingredient management support method of the present embodiment. Therefore, step S102 and step S103 described above may be omitted.

In step S105, the identifying unit 103 of the ingredient management support apparatus 100 identifies existing ingredients possessed by the user based on the information on the recipe used, additional ingredients, and surplus ingredients acquired from the user terminal 201, and sets the existing ingredients in the relevant record of the ingredient management DB 111. In this case, the identifying unit 103 identifies the ingredients excluding the additional ingredients among the ingredients used indicated by the recipe information used by the user as existing ingredients possessed by the user before making a dish using the recipe information.

In step S106, the identifying unit 103 identifies the ingredients excluding the surplus ingredients among the above-mentioned existing ingredients and additional ingredients as consumed ingredients consumed by making the dish using the recipe information, and sets them in the relevant record of the ingredient management DB 111.

In step S107, the recipe proposing unit 104 of the ingredient management support apparatus 100 collates the aforementioned information on surplus ingredients held in the ingredient management DB 111 with the information on ingredients used of each record in the recipe DB 110, and identifies recipe information with the types and quantities of required ingredients that can be satisfied with the surplus ingredients.

It should be noted that, when identifying recipe information in step S107, it is preferable that the recipe proposing unit 104 preferentially selects an ingredient that is currently possessed as a surplus ingredient even after making the dish and has a close expiration date among the additional ingredients in the ingredient management DB 111, and identifies a recipe using the selected ingredient from the recipe DB 110.

It is more preferable that the recipe proposing unit 104 identifies recipe information from the recipe DB 110 in descending order of the number of ingredients which the user needs to newly purchase, based on information on surplus ingredients held in the ingredient management DB 111 for the user (i.e., ingredients currently possessed) and the information on ingredients used of each record held in the recipe DB 110.

In step S108, the recipe proposing unit 104 delivers the recipe information identified in step S107 to the user terminal 201 for display, and terminates the processing. As the screen displayed on the user terminal 201, an example of the screen G20 shown in FIG. 7 can be assumed.

This screen G20 includes, for example, recipe information G201 to be proposed, information G202 on ingredients to be additionally purchased by the user when the recipe information is used, and information G203 on ingredients to be used based on the expiration dates among the ingredients (supposed to be) currently possessed by the user, as needed.

A user who views the screen G20 on the user terminal 200 can recognize a recipe that uses ingredients that should be consumed early among the ingredients currently possessed by the user and has few ingredients to be additionally purchased. In other words, it is possible to make effective use of the possessed ingredients and make a dish with excellent cost performance.

(Program)

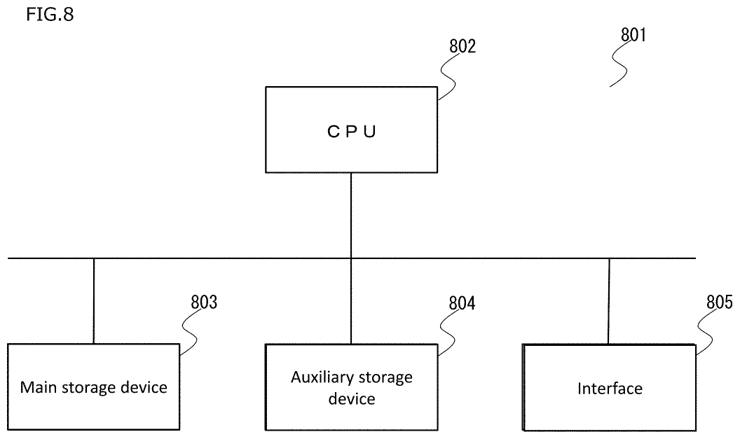

FIG. 8 is a schematic block diagram showing a configuration of the computer 801. The computer 801 includes a CPU 802, a main storage device 803, an auxiliary storage device 804, and an interface 805.

Here, a program for realizing each function that constitutes the ingredient management support apparatus 100 according to the embodiment will be described in detail.

The ingredient management support apparatus 100 is implemented in the computer 801. The operations of the constituent elements of the ingredient management support apparatus 100 are stored in the auxiliary storage device 804 in the form of a program. The CPU 802 reads out a program from the auxiliary storage device 804, expands the program in the main storage device 803, and executes the above-described processing in accordance with the program. The CPU 802 also reserves a storage area corresponding to the aforementioned storage unit in the main storage device 803 in accordance with the program.

Specifically, the program is a program which realizes, by a computer, a process of storing recipe information used by the user, confirming with the user, with regard to a dish based on the recipe information, information on surplus ingredients remaining after making the dish based on ingredient information indicated by the recipe information, and acquiring the information on surplus ingredients from a given device, and a process of identifying existing ingredients possessed by the user based on the information on surplus ingredients, on the computer 801.

It should be noted that the auxiliary storage device 804 is an example of a non-transitory tangible medium. Other examples of the non-transitory tangible medium include a magnetic disk, a magneto-optical disk, a CD-ROM, a DVD-ROM, a semiconductor memory, and the like, which are connected via the interface 805. When this program is delivered to the computer 801 via the network NW, the computer 801 that has received the program may expand the program in the main storage device 803 and execute the above-described processes.

Further, the program may be a program for realizing a part of the above-described functions. Further, the program may be a so-called differential file (differential program) which realizes the above-described functions in combination with another program already stored in the auxiliary storage apparatus 804.

Although some embodiments of the present disclosure have been described above, these embodiments can be implemented in various other forms, and various omissions, replacements, and changes can be made without departing from the spirit of the invention. These embodiments and their modifications are included in the scope and spirit of the invention and are included in the scope of the claimed inventions and their equivalents.

### EXPLANATION OF REFERENCE NUMERALS

10: Ingredient management support system
100: Ingredient management support apparatus
101: Storage unit
102: Information acquiring unit
103: Identifying unit
104: Recipe proposing unit
105: Communication Unit
110: Recipe DB
111: Ingredient management DB
200: User terminal
201: Storage unit
202: Input unit
203: Display unit
204: Communication unit
801: Computer
802: CPU
803: Main storage device
804: Auxiliary storage device
805: Interface

1. An ingredient management support apparatus comprising a processor and a memory with instructions thereon, wherein:
the memory stores recipe information used by a user; and
the instructions upon execution by the processor, cause the processor to:
confirm with the user, with regard to a dish based on the recipe information, information on a surplus ingredient remaining after making the dish, based on ingredient information indicated by the recipe information, and acquire the information on the surplus ingredient from a given device; and
identify an existing ingredient possessed by the user based on the information on the surplus ingredient.

2. The ingredient management support apparatus according to claim 1, wherein
the processor confirms with the user, with regard to the dish based on the recipe information, information on a newly purchased additional ingredient, based on the ingredient information included in the recipe information, and acquires the information on the additional ingredient from a given apparatus, and
the processor identifies the existing ingredient based on the information on the additional ingredient and the information on the surplus ingredient.

3. The ingredient management support apparatus according to claim 2, wherein the processor identifies an ingredient excluding the additional ingredient among the ingredient information as an existing ingredient possessed by the user before making the dish, identifies an ingredient excluding the surplus ingredient among the existing ingredient and the additional ingredient as a consumed ingredient consumed by making the dish, and manages the information on the existing ingredient, the additional ingredient, the consumed ingredient, and the surplus ingredient in time series.

4. The ingredient management support apparatus according to claim 1, wherein the instructions upon execution by the processor, cause the processor to:
identify a recipe of a dish that is able to be made with the surplus ingredient from the recipe information based on the information on the surplus ingredient to output information on the identified recipe.

5. The ingredient management support apparatus according to claim 4, wherein
the processor confirms with the user information on an additional ingredient newly purchased based on the ingredient information included in the recipe information, acquires the information on the additional ingredient from a given device, and executes expiration date management based on information on a purchase date of the additional ingredient indicated by the information on the additional ingredient, and
the processor preferentially selects, among the additional ingredient, an ingredient that is currently possessed as a surplus ingredient after making the dish and has a close expiration date, and identifies a recipe that uses the selected ingredient from the recipe information.

6. The ingredient management support apparatus according to claim 4, wherein processor identifies a recipe from the recipe information based on the surplus ingredient and the recipe information in descending order of a number of ingredients that need to be newly purchased.

7. An ingredient management support method in which
an information processing apparatus storing recipe information used by a user performs:
a process of confirming with the user, with regard to a dish based on the recipe information, information on a surplus ingredient remaining after making the dish, based on ingredient information indicated by the recipe information, and acquiring the information on the surplus ingredient from a given device; and
a process of identifying an existing ingredient possessed by the user based on the information on the surplus ingredient.

8. A non-transitory computer-readable medium that stores an ingredient management support program that causes an information processing apparatus storing recipe information used by a user to perform:
a process of confirming with the user, with regard to a dish based on the recipe information, information on a surplus ingredient remaining after making the dish, based on ingredient information indicated by the recipe information, and acquiring the information on the surplus ingredient from a given device; and
a process of identifying an existing ingredient possessed by the user based on the information on the surplus ingredient.
